(19) United States
(12) Patent Application Publication
(10) Pub. No.: US 2007/0079998 A1
(43) Pub. Date: Apr. 12, 2007

(54) Power barrow

(76) Inventor: Daniel J. Walter, Fort Collins, CO (US)

Correspondence Address: CR MILES, P.C.;CRAIG R. MILES, 405 MASON COURT, SUITE 119, FORT COLLINS, CO, 80524, US

(21) Appl. No.: 11/542,867

(22) Filed: Oct. 4, 2006

Related U.S. Application Data
(60) Provisional application No. 60/724,958, filed on Oct. 7, 2005.

(51) Int. Cl. B62D 51/04

(52) U.S. Cl. 180/19.1

(57) ABSTRACT

A motorized wheelbarrow having an electric motor which engages a single wheel by a drive means to generate travel of the motorized wheelbarrow over a support surface.

This United States Patent Application claims the benefit of U.S. Provisional Patent Application No. 60/724,958, filed Oct. 7, 2005, hereby incorporated by reference herein.

### I. BACKGROUND

A battery powered motorized wheelbarrow which engages an electric motor with a single wheel by a drive means to generate travel of the motorized wheelbarrow over a support surface.

Wheelbarrows pushed by persons to move materials from a first location to a second location have been described for example by U.S. Pat. Nos. 3,565,453 and 4,921,305. Certain constructional forms of wheelbarrows further include an engine to provide a motorized wheelbarrow as disclosed for example by U.S. Pat. Nos. 3,791,470; 4,589,508; 4,811,988 and 5,350,030. However, even though motorized wheelbarrows and improvements to motorized wheelbarrows have been described, a number of significant problems remain unresolved.

A first significant problem with motorized wheelbarrows may be that the motorized wheelbarrow has more than one wheel. As shown by for example by U.S. Pat. Nos. 4,811,988 and 5,350,030, motorized wheelbarrows are known which have a plurality of wheels and typically three or four wheels, but in any event more than one wheel. There does not appear to be any motorized wheelbarrows described having a single wheel constructional form.

A second significant problem with motorized wheelbarrows may be that the motor utilizes gasoline or other combustible material as a fuel. There does not appear to be disclosure of any motorized wheelbarrow which utilizes as a sole power source a battery which powers an electric motor which engages a wheel to generate travel in the motorized wheelbarrow. Specifically, there does not appear to be the constructional forms of a motorized wheel barrow as described herein which utilizes as the sole power source a battery to power an electric motor which engages a single wheel to generate travel in the motorized wheelbarrow. In the context of moving heavy loads in a wheel barrow, it can be particularly difficult to develop a practical combination of a battery and an electric motor with a drive means to engage a wheel to generate travel of the wheelbarrow. This may be particularly true of the single wheel constructional form which affords less space to locate the battery, electric motor, and drive means and may be critical to their operation.

A third significant problem with a single wheel motorized wheelbarrow can be that the battery, motor and drive means must operate properly in a numerous and wide variety of orientations relative to the single wheel or the support surface engaged to the single wheel. This is true because the conventional operation of a wheelbarrow having only a single wheel allows for rotation of a frame about the rotation axis of the single wheel located proximate to the front end of the frame as the rear end of the frame is lifted to initiate travel of the wheelbarrow from a first location to a second location. This rotation of the frame about the axis of the single wheel locates the frame in various orientations relative to the support surface engaged with the single wheel. This manner of rotation of the frame about the axis of a single wheel is entirely unlike the operation of wheelbarrows having a plurality of wheels which do not allow a significant amount of rotation of the frame about one or more of the plurality of wheels. Additionally, as a wheelbarrow with a single wheel travels it can tilt from side to side to alter the direction of travel or may be laid on its side during use. Moreover, in order to transfer materials from the load carrier of a wheelbarrow having a single wheel, the frame may be rotated about axis of the single wheel to tilt the load carrier to disgorge the materials contained within the load carrier or the wheelbarrow may be completely overturned.

A fourth significant problem can be that conventional motorized wheelbarrows have constructional forms which do not satisfy the long felt and unresolved need for a battery powered motorized wheelbarrow for general household or non-commercial use and specifically do not satisfy the long felt and unresolved need for a single wheel constructional form of a motorized wheelbarrow which has a battery as the sole power source for an electric motor which engages the single wheel to generate travel over the support surface.

### II. SUMMARY OF THE INVENTION

Accordingly, a broad object of the invention can be to provide a single wheeled power barrow which includes a battery powered electric motor that engages a single wheel by a drive means to generate travel over a support surface from a first location to a second location.

A second broad object of the invention can be to provide specific configurations of batteries, electric motors and drive means which are compatible with motorizing single wheeled constructional forms of wheel barrows (or other constructional forms of wheel barrows having a greater number of wheels one of which can be engaged to an battery powered electric motor by the drive means described herein).

A third broad object of the invention can be to provide a motorized wheelbarrow having a battery and a battery powered electric motor which can operate to engage a wheel by a drive means to generate travel in the wheelbarrow regardless of the orientation of the motorized wheelbarrow, or frame of the wheelbarrow, relative to the single wheel or the support surface.

Naturally, further objects of the invention are disclosed throughout other areas of the specification, drawings, photographs, and claims.

### III. A BRIEF DESCRIPTION OF THE DRAWINGS

FIG. 1 provides an illustration showing a particular method of using the inventive power barrow.

FIG. 2 is a top view of a particular embodiment of the inventive power barrow.

FIG. 3 is a side view of a particular embodiment of the inventive power barrow.

FIG. 4 is front end view of a particular embodiment of the inventive power barrow.

FIG. 5 is a bottom view of a particular embodiment of the inventive power barrow.

FIG. 6 is an exploded view of a particular embodiment of the inventive power barrow.

### IV. DETAILED DESCRIPTION OF THE PREFERRED EMBODIMENTS

A motorized wheelbarrow having an electric motor which engages a single wheel by a drive means to generate travel of the motorized wheelbarrow over a support surface.

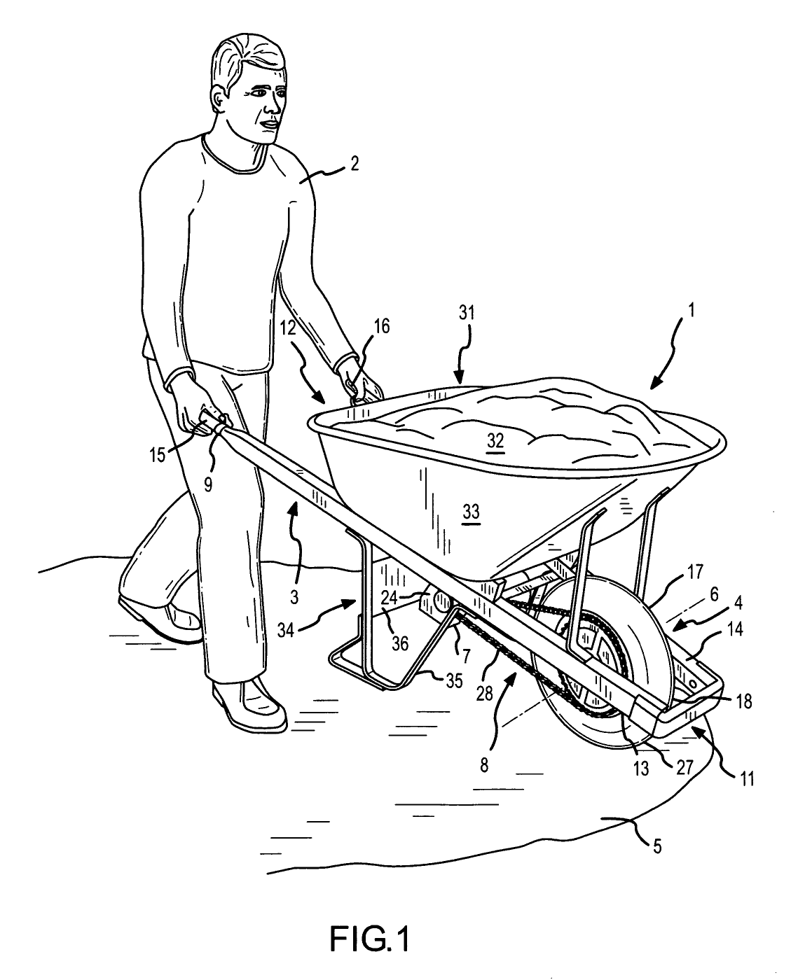

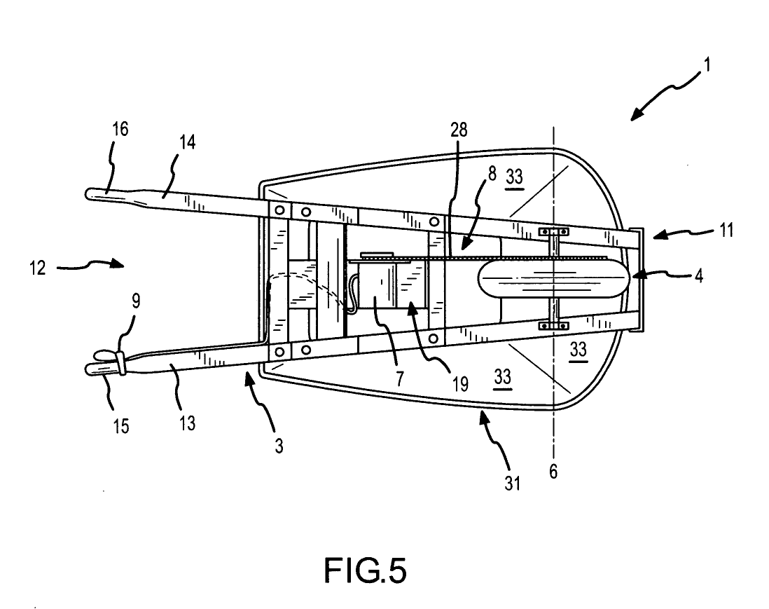

Now referring primarily to FIG. 1, a method of using a particular embodiment of the inventive motorized wheelbarrow (or power barrow) (1) is shown. A person (2) by gripping a frame (3) rotatably coupled to a single drive wheel (4) engaged with a support surface (5) can lift the frame (3) a distance above the support surface (5) by rotation of the frame (3) about the rotation axis (6) of the single drive wheel (4). Then by initiating operation of a electric motor (7) (see also FIG. 5) coupled to a drive means (8) which engages the electric motor (7) with the single drive wheel (4), rotation can be generated in the single drive wheel (4) about the rotation axis (6) to generate travel of the power barrow (1) a distance over the support surface (5).

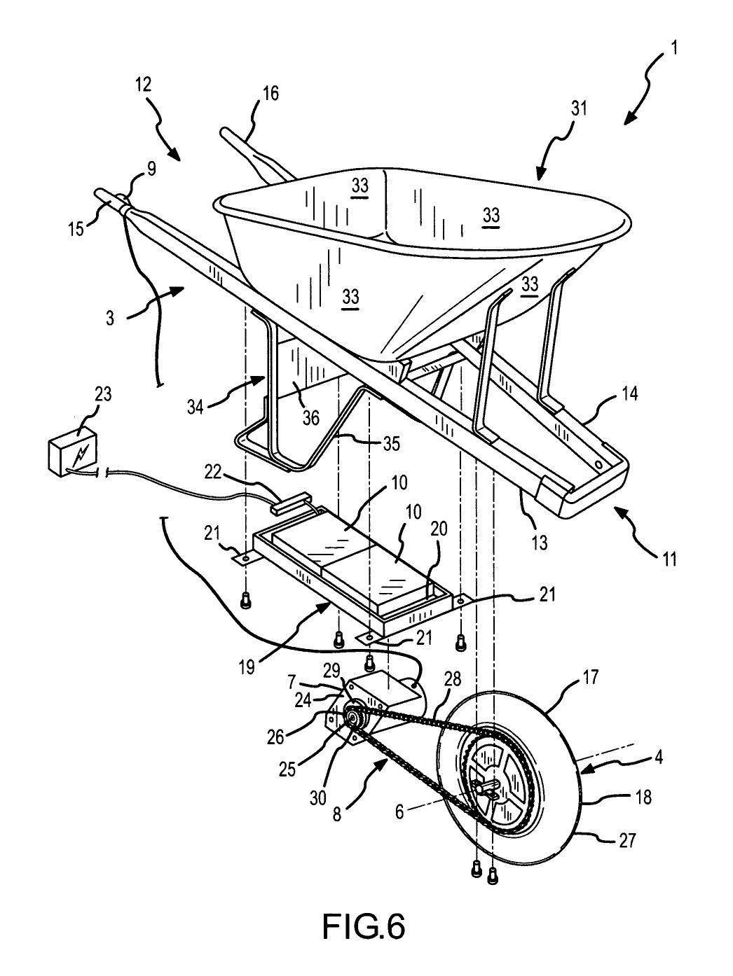

By operating an electric motor speed controller (9), the person (2) can adjust the rate at which the single drive wheel (4) rotates about the rotation axis (6) or the amount of power delivered by the drive means (8) to the single wheel (4). The person (2) can by applying force proximate to the rear of the frame (3) in the direction of travel assist the drive means (8) in rotating the single drive wheel (4) engaged with the support surface (5) to generate the desired distance or rate of travel in the power barrow (1) over the support surface (5). Recharging of the battery (10) (see FIG. 6) which provides power to the electric motor (7) can be accomplished by operation of a charging circuit (11) (see FIG. 6) coupled to the battery (10).

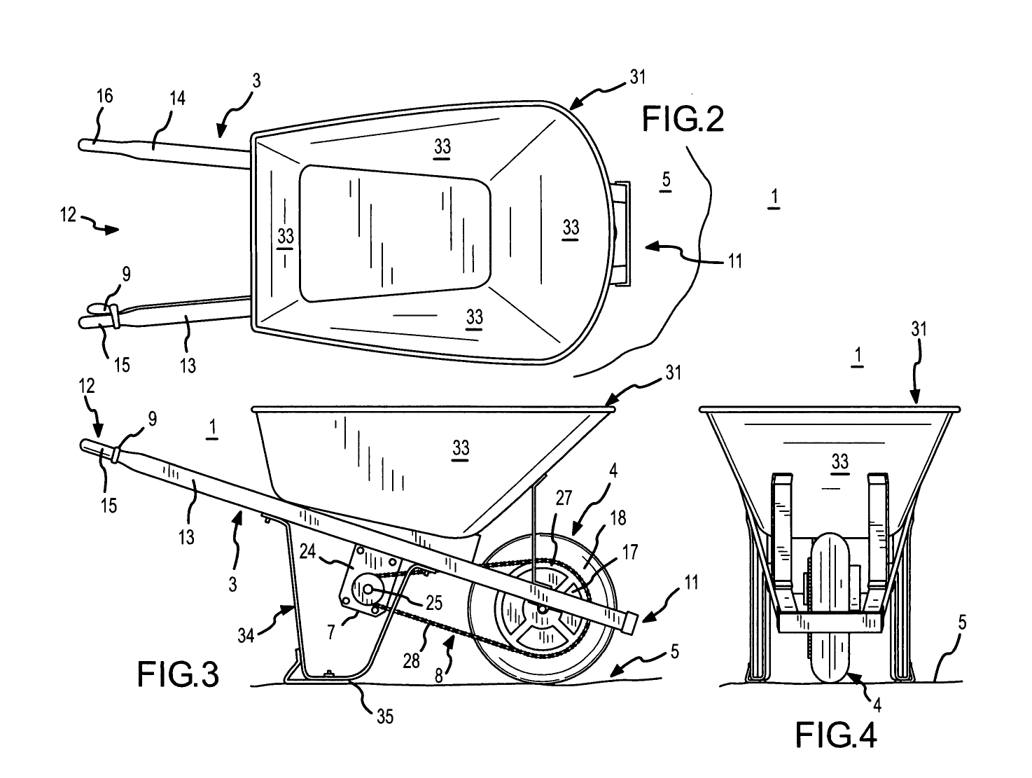

Now referring primarily to FIGS. 2-5, a particular embodiment of the power barrow (1) is shown which can include a frame (3) having a front end (11) and a rear end (12) and a single wheel (4) (or single drive wheel) rotatably coupled proximate to the front end (11) of the frame (3). The term frame (3) as used in this description broadly includes any constructional form of members capable of being rotatably coupled to the single wheel (4) proximate to a front end (11) of the frame (3) to allow a person (2) to grip the frame (3) proximate to the rear end (12) so that it can be lifted a distance above the support surface which engages the single wheel (4) rotatably coupled proximate to the front end (11) of the frame (3). A preferred embodiment of the power barrow (1) provides a frame (3) as shown by FIGS. 2-4 having a pair of members (13)(14) set a distance apart with the single wheel (4) rotatably coupled between the pair of members (13)(14) proximate to the front end (11). The pair of members (13)(14) terminate at the rear end (12) in a pair of grips (15)(16). This preferred embodiment of the frame (3) shown by FIGS. 2-4 is not intended to be limiting with respect to the numerous and varied frames (3) which can be utilized with the inventive power barrow (1). Similarly, the drive wheel (4) can include a wide variety of constructional forms which may be of a lesser or greater diameter, but of sufficient diameter such that when engaged with the support surface (5) the front end (11) of the frame (3) can be maintained a distance above the support surface (5). The single wheel (4) can be a single integral piece, or for example, can comprise a rim element (17) coupled to an annular member (18).

Now referring primarily to FIG. 6, a battery (10) can be mounted to the frame (3). The battery (10) can comprise a single battery or can comprise a pair of batteries or a plurality of batteries coupled by circuitry in parallel or in series to deliver the proper voltage and power. A preferred embodiment of the inventive power barrow (1) can utilize a pair of batteries as shown which can be wired in series to provide 24 volts direct current. A sealed maintenance free rechargeable direct current twelve volt battery (10) (such as model number BP10-12 distributed by B&B Battery USA, Inc. 20 hour rate 500 mA to 10.50 volts—10.0 amp hours) can be utilized in various embodiments of the inventive power barrow (1). Alternately, a rechargeable 24 volt 10 amp hour nickel cadmium battery could also be utilized in various embodiments of the power barrow (1). With respect to certain embodiments of the inventive power barrow (1) the battery (10)(or batteries) can coupled to the frame indirectly by further utilizing a battery mount (19) configured to couple to one or to a plurality of constructional forms of the frame (3). The battery (10) can then be coupled to the external surface of the battery mount (19). In the particular embodiment of the power barrow (1) shown by FIG. 6, the battery mount (19) includes a rectangular member (20) configured to be disposed between the pair of frame members (13)(14). A plurality of projection elements (21) extend from the rectangular member (20) such the projection elements (21) can be fixedly engaged by fasteners to each of the pair of frame members (13)(14). A pair of batteries (10)(such as model BP10-2) can then be mechanically fastened to the rectangular substantially planar surface of the rectangular member (20). The battery (10) can include a battery recharge module (22)(such as included in model number BP 10-12 battery above described) which includes a battery recharge circuit which allows the battery to be recharged by electrically coupling the recharge module (22)(such as a to a external power source (23) such as a 110 volt alternating current power source.

Again referring primarily to FIG. 6, the inventive power barrow (1) can further include an electric motor (7) mounted to the frame (3) and electrically coupled to the battery (10) which provides sufficient electrical energy for normal operation or operation consistent with the invention as herein described. Again while the electrical motor can be coupled directly to the frame (3), as to certain embodiments of the power barrow (1), the electric motor can be coupled indirectly to the frame by further utilizing a motor mount (24) which joins to the frame (3), or as shown by FIG. 6 joins to the battery mount (19)(whether by fasteners, welded joint, or otherwise) to provide an external surface to which the electric motor (7) can be fixedly engaged by use of mechanical fasteners or other securement means. The motor mount (24) engages the electric motor (7) to fix the motor shaft (25) at a location which allows the drive means (8) to engage the electric motor (7) with the single drive wheel (4).

While numerous and varied electrical motors can be utilized with the invention, the electrical motor (7) has to be electrically compatible with the battery (10) mounted to the frame (3) and use for the intended purpose of driving the single wheel to generate travel in the power barrow (1). An electric motor (7) which can be used with the sealed maintenance free rechargeable twelve volt battery or nickel cadmium batteries above-described is a 24 volt 400 watt electrical motor, such as a KOLLMORGAN 24 volt 400 watt brushless motor which can be obtained with a built in variable motor speed controller circuit operable with the motor speed controller (9)(specific to the KOLLMORGAN electric motor the motor speed controller can comprise a 5 k Ohm potentiometer for example) from suppliers such as Superkids Online, LLC, 1550 Erwin Street, Suite 1085, Van Nuys, Calif. 91411.

Again referring to primarily to FIG. 6, the inventive power barrow (1) can further include a drive means (8) which engages the electric motor (7) with the single wheel (4). The drive means (8) can include a drive element (26) such as a drive gear, a drive pulley, a drive sprocket (or the like) which upon rotation generates rotation in a driven element (27) such as a driven gear, a driven pulley or driven sprocket (or the like) by way of a circumferentially continuous drive element (28) such as a belt or link chain. The driven element (27) engages the single wheel (4) such that rotation of the driven element (27) rotates the single wheel (4) about the rotation axis (6).

The drive element (26) couples to the motor shaft (25) such that as the motor shaft (25) rotates the drive element (26) rotates, or rotates when the motor shaft (25) rotates at a particular speed or within a particular range of particular speeds. Embodiments of the drive element (26) can comprise a sprocket having between ten teeth and twenty teeth. With particular embodiments of the drive element (26) having an 11 tooth, 15 tooth or a 19 tooth sprocket.

As to certain embodiments of the inventive power barrow (1), the drive means (8) can further include a reduction unit (29) disposed between the motor shaft (25) and the drive element (26) which reduces the speed at which the drive element (26) rotates relative to the speed at which the motor shaft (25) rotates. A particular reduction unit (29) which can be utilized with the drive means (8) can be a set of planetary gears such as the planetary gear assembly available from Superkids Online, LLC, 1550 Erwin Street, Suite 1085, Van Nuys, Calif. 91411, part number: sk-planetg.

The drive means (8) can further include a clutch (30) coupled between the motor shaft (25) and the drive element (26), or as to those embodiments of the drive means (8) which include the reduction unit (29), between the reduction unit (29) and the drive element (26). While numerous and varied clutches (30) such as centrifugal clutches, torque clutches, or roller bearing clutches can be utilized in the drive means (8), a particular clutch (30) which provides an integral drive element (26) and can be utilized with the above-describe planetary gear assembly is a Currie roller clutch assembly available from NYCEWHEELS, Inc., 1603 York Avenue, New York, N.Y. 10028 or the pinion gear & roller clutch assembly available from Superkids Online, LLC, 1550 Erwin Street, Suite 1085, Van Nuys, Calif. 91411, part number: sk-pinion.

The driven element (27) can be coupled to the single wheel (4) such that upon engagement with the electric motor (7) rotation occurs about the rotation axis (6) of the single wheel (4). While the driven element (27) can comprise a driven gear, a pulley, a sprocket, or the like, a particular embodiment of the invention as shown by FIG. 6 comprises a ninety tooth sprocket such as the sprocket available from Superkids Online, LLC, 1550 Erwin Street, Suite 1085, Van Nuys, Calif. 91411, part number: sk-sprocket.

The circumferentially continuous drive element (28) can be a belt mated to the pulleys utilized for the drive element (26) and the driven element (27) or can be a drive chain mated with the teeth on sprockets utilized for the drive element (26) and the driven element. As to the particular ninety tooth sprocket and the pinion gear clutch assembly above-described a chain can be obtained from Superkids Online, LLC, 1550 Erwin Street, Suite 1085, Van Nuys, Calif. 91411, part number: sk-echain.

Now referring to FIGS. 1-6, the inventive power barrow (1) can further include a load carrier (31) which can be fixedly engaged to the frame (3). The load carrier (31) can have numerous and varied constructional forms and the particular embodiment of the load carrier shown by the figures is not intended to be limiting with respect to the invention. Rather, the load carrier (31) can be configured to carry any manner of material (32) whether particulate or granular in form as shown in FIG. 1 which may require a load carrier (31) having sides (33) or sheet materials which may require the load carrier to be configured to provide a substantially planar surface on which the sheet materials lie.

Again referring to FIGS. 1-6, the inventive power barrow (1) can further provide a frame support member (34) disposed between the frame (3) and the support surface (5) which maintains the rear end (12) of the frame (3) elevated a distance above the support surface (5). While the particular frame support member (34) shown in the figures includes a pair of U-shaped brackets (35) coupled one each to the frame (3) with a cross member (36) coupled between the pair of U-shaped brackets (35), the invention is not so limited and any construction form of the frame support member (34) can be utilized so long as it functions to maintain the rear end (12) of the frame (3) elevated a distance above the support surface (5). As such, posts, columns, tubular legs, or the like could be interchangeably utilized.

As can be easily understood from the foregoing, the basic concepts of the present invention may be embodied in a variety of ways. The invention involves numerous and varied embodiments of a battery powered barrow and method of using such battery powered barrow.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “load carrier” should be understood to encompass disclosure of the act of “load carrying”—whether explicitly discussed or not—and, conversely, were there effectively disclosure of the act of “load carrying”, such a disclosure should be understood to encompass disclosure of a “load carrier” and even a “means for carrying.” Such alternative terms for each element or step are to be understood to be explicitly included in the description.

In addition, as to each term used it should be understood that unless its utilization in this application is inconsistent with such interpretation, common dictionary definitions should be understood to included in the description for each term as contained in the Random House Webster's Unabridged Dictionary, second edition, each definition hereby incorporated by reference.

Thus, the applicant(s) should be understood to claim at least: i) each of the compositions or extracts herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

The claims set forth below are intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. A method of making a barrow, comprising the steps of:
(a) providing a frame having a front end and a rear end, wherein said frame has a single wheel rotatably coupled proximate to said front end of said frame;
(b) mounting a battery to said frame;
(c) mounting an electric motor to said frame;
(d) powering said electric motor with electrical energy from said battery; and
(e) coupling a drive means to engage said electric motor with said single wheel, whereby operation of said electric motor generates rotation of said single wheel.

2. A method of making a barrow as described in claim 1, further comprising mounting a motor speed controller proximate to said rear end of said frame, wherein said motor speed controller allows variable adjustment of rotational speed of said electric motor.

3. A method of making a barrow as described in claim 2, further comprising coupling a load carrier to said frame.

4. A method of making a barrow as described in claim 3, further comprising the step of coupling a frame support member to said frame, wherein engagement of said frame support member and said single wheel with a support surface establishes said frame at a height above said support surface.

5. A method of making a barrow as described in claim 4, wherein said step of mounting a battery to said frame comprises mounting a pair of batteries to said frame configured to generate about 24 volts direct current.

6. A method of making a barrow as described in claim 5, wherein said step of mounting an electric motor to said frame comprises mounting a 24 volt direct current electric motor.

7. A method of making a barrow as described in claim 6, wherein said step of coupling a drive means to engage said electric motor with said single wheel comprises the steps of:
(a) coupling a reduction unit to said motor shaft of said electric motor;
(b) coupling a clutch between said reduction unit and said drive element which generates rotation of said motor element based on rotational speed of said motor shaft;
(c) coupling a driven element to said single wheel, wherein rotation of said driven element rotates said single wheel; and
(d) engaging a circumferentially continuous drive element to said drive element and to said driven element, wherein rotation of said drive element generates rotation of said driven element.

8. A method of making a barrow as described in claim 7, further comprising the step of selecting said drive element from the group consisting of: a sprocket and a pulley.

9. A method of making a barrow as described in claim 8, further comprising the step of selecting said driven element from the group consisting of: a sprocket and a pulley.

10. A method of making a barrow as described in claim 9, further comprising the step of selecting said circumferentially continuous drive element from the group consisting of: a drive chain configured to mate with a plurality of teeth of said drive element and a plurality of teeth of said driven member, and a belt configured to mate with groove of a said drive element and a groove of said driven element.

11. A method of making a barrow as described in claim 10, wherein said step of providing a frame having a front end and a rear end, wherein said frame has a single wheel rotatably coupled proximate to said front end of said frame comprises the step of providing a pair of frame members disposed a distance apart between which a single wheel rotatably couples proximate to said front end of said frame.

12. A power barrow, comprising:
(a) a frame having a front end and a rear end, wherein said frame has a single wheel rotatably coupled proximate to said front end of said frame;
(b) a battery mounted to said frame;
(c) an electric motor mounted to said frame said battery electrically coupled to said electric motor; and
(d) a drive means which engages said electric motor with said single wheel.

13. A power barrow as described in claim 12, further comprising a load carrier coupled to said frame at a location between said front end and said rear end.

14. A power barrow as described in claim 13, further comprising a stabilizer support coupled to said frame at a location rearward of said single drive wheel.

15. A power barrow as described in claim 14, further comprising a motor speed control mounted to said frame proximate to said rear end; and

16. A power barrow as described in claim 15, wherein said electric motor comprises a 24 volt direct current electric motor.

17. A power barrow as described in claim 16, wherein said battery comprises a pair batteries which are configured to generate 24 volts direct current.

18.-27. (canceled)
